(19) United States
(12) Patent Application Publication
(10) Pub. No.: US 2026/0315916 A1
(43) Pub. Date: Oct. 15, 2026

(54) STREAMING A GAME BASED ON A CLOUD EXECUTION OF A UNIVERSAL GRAPHICS ENGINE

(71) Applicant: Sony Interactive Entertainment Inc., Tokyo (JP)

(72) Inventors: Murshed Choudhury, Foster City, CA (US); Jeffrey R. Stafford, Redwood City, CA (US); Ueli Gallizzi, Laguna Niguel, CA (US)

(73) Assignee: Sony Interactive Entertainment Inc., Tokyo (JP)

(21) Appl. No.: 19/647,567

(22) Filed: Apr. 14, 2026

Related U.S. Application Data
(60) Provisional application No. 63/789,040, filed on Apr. 15, 2025.

(51) Int. Cl. A63F 13/355; A63F 13/335; A63F 13/55

(52) U.S. Cl. CPC A63F 13/355; A63F 13/335; A63F 13/55

(57) ABSTRACT

Methods, systems, and code can provide enhancements that can make video games more immersive. An example can extract one or more characters or other 3D models from an executing game program, transform them to an alternative space, and render them in the alternative space for viewing using an augmented-reality headset or other display device. This can allow a user to play a game with game characters in the user’s living room or other space. This insertion of virtual characters into a user’s real-world space can make the game very immersive. Embodiments of the present invention can accomplish this without changes to the underlying game program.

### CROSS-REFERENCES TO RELATED APPLICATIONS

The application claims the benefit of U.S. provisional patent application number 63/789,040, filed Apr. 15, 2025, which is incorporated herein by reference in its entirety for all purposes.

### BACKGROUND

Video games can be an incredibly immersive form of entertainment. Whether played alone or in groups over the internet, video games can be challenging and engaging. For some games, player immersion can be enhanced with the inclusion of life-like characters, highly detailed virtual worlds, and other amazing enhanced graphical effects. Thus, what is needed are methods, systems, and code that can provide enhancements to video games that can make video games even more immersive.

### BRIEF DESCRIPTION OF THE DRAWINGS

FIG. 1 illustrates a method of displaying characters in a game according to an embodiment of the present invention;

FIG. 2 illustrates a gaming system according to an embodiment of the present invention;

FIG. 3 illustrates a method of operating a gaming system according to an embodiment of the present invention;

FIG. 4 illustrates another method of operating a gaming system according to an embodiment of the present invention;

FIG. 5 illustrates a gaming system according to an embodiment of the present invention;

FIG. 6 illustrates a method of operating a gaming system according to an embodiment of the present invention;

FIG. 7 illustrates gameplay provided by an embodiment of the present invention;

FIG. 8 illustrates gameplay provided by an embodiment of the present invention;

FIG. 9 illustrates a method of remapping a control to compensate for movement of a player during a game;

FIG. 10A and FIG. 10B illustrate a remapping of a control to compensate for movement of a player during a game;

FIG. 11 illustrates gameplay provided by an embodiment of the present invention;

FIG. 12 illustrates a controller that can be utilized by an embodiment of the present invention;

FIG. 13 is a block diagram of a controller according to an embodiment of the present invention;

FIG. 14 illustrates a handheld device according to an embodiment of the present invention; and

FIG. 15 illustrates a simplified block diagram of a hardware system suitable for implementing a console or other computer system according to an embodiment of the present invention.

### DESCRIPTION OF ILLUSTRATIVE EMBODIMENTS

Embodiments of the present invention can provide methods, systems, and code that can provide enhancements to make video games more immersive. An illustrative embodiment of the present invention can extract one or more game assets (for example for one or more models for characters) from a video game in real time and render them in a single consistent space for consuming using an augmented or virtual-reality headset, tablet, smartphone, handheld gaming device, or other spatial device that is aware of its spatial location and direction in the real world and that can be used to play video games. This can allow a user to play a game with the characters positioned (virtually) in the user’s living room or other space. This insertion of virtual characters into a user’s real-world space can make the game very immersive. Embodiments of the present invention can accomplish this without needing to modify the underlying game.

In an illustrative embodiment, a game program can use assets (for example 3D models) for one or more characters or other objects, such as combatants of a fighting game. The game program can also use assets for background and foreground environmental structures, such as ceilings, walls, floors, chairs, and the like. Specific API calls, like Graphics API Draw calls, and other draw call information and related commands and data can be provided by the game program for rendering the combatants, as well as the background and foreground environmental structures. Instead of rendering all the draw calls provided by the game program, the draw calls and related commands and data for the combatants can be rendered and displayed, while the draw calls and related commands and data for 3D models other than the combatants, such as the ceilings, walls, floors, and chairs, can be ignored or discarded. That is, draw calls and related commands and data for 3D models, the combatants, can be rendered, while the draw calls and related commands and data for other 3D models, the floor etc., can be ignored. Put another way, draw calls and related commands and data for 3D models that are being extracted, the combatants, can be rendered, while the draw calls and related commands and data for other 3D models, the floor etc., can be ignored. This reduction in the amount of data can reduce computational and network congestion or alternatively present a different kind of user experience.

These and other embodiments of the present invention can be executed on different types of systems. For example, a cloud-based data server can execute a game program that uses assets including one or more 3D models for one or more corresponding characters, as well as other 3D models for other objects in the game. During an initialization, draw call information and other commands and data for the one or more 3D models for the one or more characters can be intercepted and transmitted to a client while the remaining 3D models for other objects are not sent to the client, that is, the remaining 3D models for other objects can be ignored. The client can render the one or more received 3D models for the one or more characters. The client can then display the one or more characters in alternative coordinate space from the original game on a display that is part of or otherwise associated with the client. Updates to the position of the one or more 3D models for the one or more characters can be generated by the execution of the game program, intercepted via the data passed to a Graphics API, and transmitted to the client. The client can receive the updates and render the one or more characters in their updated positions within the alternative space.

In another example, a console, personal computer, or other device (referred to here as a console for simplicity) can execute a game program that includes one or more 3D models for one or more corresponding characters, as well as 3D models for other structures in the game. During an initialization, data for the one or more 3D models for the one or more characters can be received and stored by circuitry on the console. This console circuitry can render the one or more 3D models in the game’s coordinate space. Additionally or alternatively, the console circuitry can then display the one or more 3D models in an alternative coordinate space on a display that is part of or otherwise associated with the console and can be spatially located in the real world. Updates to the position of the one or more 3D models for the one or more characters can be generated by the game program and displayed. The console circuitry can receive the updates and render the one or more characters in their updated positions in the alternative coordinate space.

The model initialization and update data can include different types of data. For example, vertices, indices, textures, shaders, shader parameters, and other graphics data can be included. In addition, 3D model data, 2D visual data, audio and haptic data can be included.

The 3D model information and its updates can be received for rendering in various ways. In these and other embodiments of the present invention, draw call information and related commands and data for one or more 3D models for characters (or other 3D models and game assets of interest) can be intercepted at an Application Programming Interface (API) of a server and sent to a client for rendering and placement in an alternative coordinate space, while draw call information and related commands and data for other 3D models can be ignored. Where draw call information is intercepted, that is removed from the data stream into the API, a graphics processing unit (GPU) in the server that follows the API might be at least partially disabled or allocated elsewhere as it might not be needed for this game. Alternatively, an API can be snooped or monitored and draw call information and other graphics and related commands and data for the characters or other assets of interest can be copied instead of being intercepted. In a cloud-based or streaming-based system, draw call information and related commands and data can be sent to a client for rendering and placement in an alternative coordinate space that represents the real-world space of a client device. The copying of data in such a system can slow the processing of the game program, though the impact of these memory transfers can be minimal. In a console-based system with appropriate hardware support, only the draw call information and game assets and related commands and data for a set of one or more 3D models might be passed by the API to the following GPU of the console, while the other draw call information is not sent to the GPU. Alternatively, in a cloud-based and/or console-based system, the draw call information can be directly written to two memory buffers at the same time, with one memory buffer being used by the game program, while the other memory buffer can be used by a process that determines how to transform the assets from the game’s coordinate space to the alternative coordinate space used by a spatial client device for rendering, thereby allowing the game program to continue unimpeded.

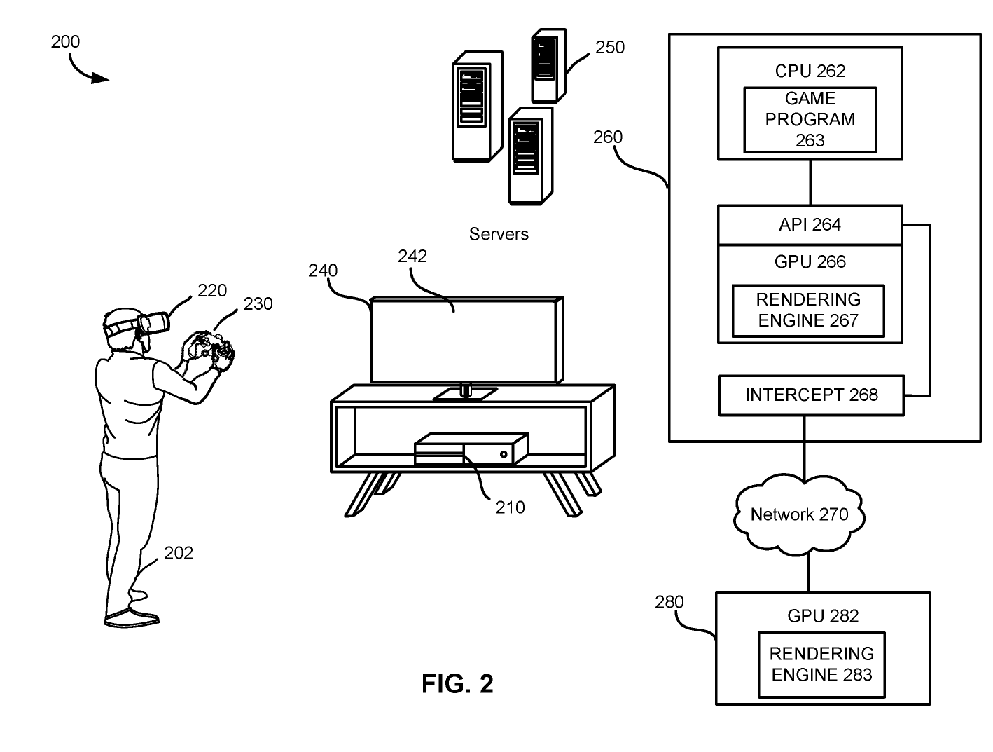

In a first example, in the system shown in FIG. 2 shown below, a server can intercept draw call information and other data and commands for a game program, including those for a set of one or more 3D models or other 3D visual data, 2D models or other 2D visual data, audio and haptic data or other game assets (collectively referred to here simply as models or 3D models for brevity.) The server can send the draw call information and other data and commands for the set of one or more 3D models to a console and can omit from sending draw call information that is for 3D models not in the set of one or more 3D models. A console can receive the draw call information and other data and commands for the set of 3D models from the server over a network and can send them to a headset to be transformed to the coordinate space of the headset, which can be the physical environment around a player, and then rendered and displayed.

In a second example, in the system shown in FIG. 2 shown below, a server can intercept draw call information and other data and commands for a game program, including those for a set of one or more 3D models. The server can send the draw call information and other data and commands for the set of one or more 3D models to a headset and can omit from sending draw call information that is for 3D models not in the set of one or more 3D models. The headset can include a GPU. The headset can receive the draw call information and other data and commands for the set of one or more 3D models from the server over a network to a headset. The 3D models can be transformed to a coordinate space of the headset, which can be the physical environment around a player, and then rendered and displayed on a screen of the headset.

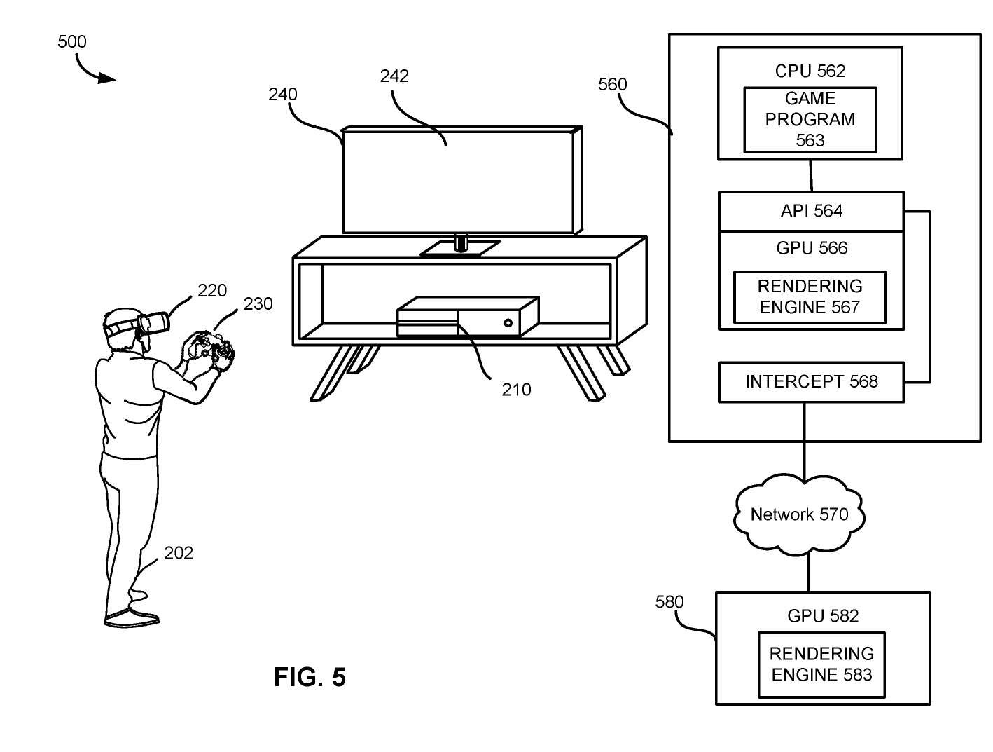

In a third example, in the system shown in FIG. 5, a console can intercept draw call information and other data and commands for a game program, including those for a set of one or more 3D models. The console can render the set of one or more 3D models and send them over a Wi-Fi or other network to a headset and can omit from sending draw call information that is for 3D models not in the set of one or more 3D models. The headset can then transform the set of 3D models to the view that is seen in the pass-through mode of the headset, in other words, the headset’s coordinate space, and then render and display the models.

In a fourth example, in the system shown in FIG. 5, a console can intercept draw call information and other data and commands for a game program, including those for a set of one or more 3D models. The console can send the draw call information and other data and commands for the set of one or more 3D models to a headset and can omit from sending draw call information that is for 3D models not in the set of one or more 3D models. The headset can include a GPU. The headset can receive the draw call information and other data and commands for the set of 3D models from server over network to the headset. The 3D models can be transformed to the coordinate space of the headset, which can be the physical environment around a player, and rendered and displayed on a screen of the headset.

In these and other embodiments of the present invention, the one or more 3D models can be rendered in an alternative coordinate space where that space can be the physical space that can be seen by a game player. For example, where a headset is used, the area around a user can be mapped during an initialization period. The one or more 3D models can then be transformed and rendered into this mapped space. In these and other embodiments of the present invention, the alternative space can be a virtual environment. In these embodiments physical objects in the real world can have virtual counterparts in the virtual space.

Various types of displays can be used in these and other embodiments of the present invention. For example, a virtual-reality headset can be used to display an augmented-reality view of one or more 3D models from a game placed in a pass-through image. In another example, a camera on a handheld device can be used to provide an alternate view on a display of the tablet or otherwise associated with the handheld device. One or more 3D models from a game can be rendered and displayed in the alternative view on the display. In another example, one or more 3D models can be rendered in the alternative coordinate space seen through a pair of augmented-reality glasses. In another example, a camera on a phone can be used to provide the alternative view on a display of the phone or otherwise associated with the phone. One or more 3D models from a game can be rendered and displayed in the alternative view on the display.

Various 3D models from a game can be extracted and sent to a client device for display, while others are ignored and not sent to the client. For example, in a fighting game, 3D models for one or more combatants can be extracted and rendered in the alternative coordinate space, while other 3D models, such as those for floors and ceilings, are omitted. Such a game is entertaining and works well with embodiments of the present invention since a limited amount of model data needs to be transferred initially and then updated during game play. In such a game, 3D models that can be used by the characters, such as boxing gloves, protective gear, or other handheld or wearable objects, as well as other 3D models, can be sent with the initial data and updated as the game progresses.

Applying embodiments of the present invention to a fighting game, or other game where the characters interact, can provide various advantages. For example, in an illustrative embodiment of the present invention, 3D models for characters from a fighting game can be extracted from a game and placed in a coordinate space corresponding to a user’s physical environment using an augmented-reality device. In the fighting game, only the characters themselves and items that they interact with might need to be initially transferred and updated. That is, only a limited number of 3D models, for example two 3D models for two character combatants, might need to be initially transferred and updated since each character can be limited to interacting with the other. Additional 3D models for items the combatants might use and interact with can be initially transferred and updated as well. 3D models that are not interacted with by the combatants might not be transferred. Conversely, games where characters do interact with other items in a scene, such rocks, hills, plants, walls, doors, and the like, can increase the amount of data transferred, thereby improving system efficiency.

Another advantage of transferring a fighting game , or other game where the characters interact, can be that the game takes place in a linear space. That is, the game program might provide a two-dimensional view of the fighters where they fight moving to the left and right, where the camera provides a view as if it were on a rail that limits the point-of-view to two dimensions, though the characters themselves can have three-dimensions. This embodiment can facilitate the transformation of the fighting characters into a coordinate space that is a user’s environment. Such a limited movement space for the characters can make it easier for the virtual characters to be positioned such to avoid physical obstacles such as furniture and walls.

While embodiments of the present invention are well-suited to using 3D models, in these and other embodiments of the present invention, 2D models (and 2D characters) can be used.

Where fighting characters can move in additional dimensions (front-to-back, up and down), more data might need to be transferred, and it might be more difficult to confine the character positions and movements to avoid real-world obstacles. Accordingly, embodiments of the present invention can adjust the relative position of the virtual characters in real space. That is, instead of placing two combatants 5 meters apart, they can be rendered to be 2 meters away from each other. Also, the relative velocities with which they move towards and away from each other can be varied to compensate for the change in spacing between characters. As an example, in game space, the characters can begin 6 meters apart and move to close the gap to 3 meters in 1 second, for a velocity of 3 meters per second. To reduce the real-world area that is needed, on the client the characters can be rendered to begin at 4 meters apart and move to close the gap to 2 meters in 1 second, for a reduced velocity of 2 meters per second. This can help to maintain a logical position between rendered characters in a reduced area.

The rendered combatants can be rendered in a coordinate space that is an area around a game player. That is, one or more characters can be rendered in coordinate space where the coordinate space can be the physical space that can be seen by the game player. For example, where a headset is used, the physical area around a user can be mapped during an initialization period. The one or more combatants can then be rendered into this mapped space. Where it is known that the combatants can move in different directions an equal amount, the combatants can be positioned towards the middle of the available area. Where it is known that that the combatants have more range in a first direction, the combatants can be positioned away from the middle of the available area to provide more range for movement in the first direction. This can further help to avoid obstructions caused by the transformation from the coordinate space in the game to the alternative coordinate space representing the real world as seen by the game player.

These and other embodiments of the present invention can add additional images on the client side for display. For example, a game player might map out an area using a headset or other device. The mapped area might include a glass window. A fun addition can be made to the game by determining when a character encounters the window and then adding a series of images showing the window breaking in response. The broken window can then replace the actual window in an augmented reality stream provided to the user’s display. The series of breaking window images can be AI generated.

Often there can be interesting or useful images displayed by a game, where the images are not interacted with by the characters. Instead of losing these images when they are not transferred to the client, these images can instead be repurposed. For example, an image of a beautiful view rendered by the game program can be repurposed as an image in a painting or on a television rendered by the client. That is, the image of interest can be transferred to the client as additional asset information. The image can then be transformed and rendered by the client as an image on an actual television in the user’s area, the client can transform and render a virtual television and then display the image on the virtual television, the client can transform and render the image as a picture on a wall in the user’s area, the client can transform and render the image as a virtual reflection on a real-world window or mirror, or the client can transform and render the image in another location.

In some circumstances, a game player can move in an area where the combatants are fighting (virtually.) For example, a user can wear a headset and control a first combatant in an area that has been mapped by the headset. The user can then move relative to the combatants. The movement can change the view of the combatants that the user sees. But without more, the controls for moving the character the user plays do not change. This can lead to a user moving a control in a direction that might be expected to have the fighter move forward, but the fighter might instead move to the left. Accordingly, embodiments of the present invention can track the user’s movement and remap the controls accordingly. This change can be optional and under the user’s control.

As an example, a user can play a game where the characters can move left and right as viewed from the user’s position. To move a character on the right side to the left, the user can move a control, such as a joystick, D-pad, or other control input on a controller, to the left. The user might move to the right of the two combatants. Without more, when the user wants their fighter to move away from the user (again to the left as viewed from the user’s previous position) the user would need to move the control to the left. This can be in contrast to moving the control in the more intuitive up direction. Accordingly, embodiments of the present invention can remap the controls such that moving control in the up direction can result in the user’s fighter moving away from the user. That is, initially a first function can be mapped to the control. With the first function, a character can move to the left when the control is moved to the left. When the player moves to the right, a second function can be mapped to the control. With the second function, a character can move away from the user when the control is moved up. This remapping can provide intuitive control of the movement of a character using the control of a controller as the player moves around the character.

In these and other embodiments of the present invention, the change in control mapping can occur in various ways. For example, no change in mapping might occur until a user moves 90 degrees (π/2 radians) relative from an original position. In other examples, once a user has moved more than 45 degrees (π/4 radians), a remapping can occur. In other examples, once a user has moved more than 22.5 (π/8 radians) degrees, a remapping can occur. In other examples, the remapping can be continuous, or near continuous, as a user moves relative to the combatants or other characters.

In the above example, a user can control a character using a joystick, D-pad, or other input device. Additionally, a user can control a character by tilting or turning the controller. Movement of the user can be tracked by the spatial tracking (determining position and orientation relative to a real-world origin) mechanisms of a headset worn by the user. In these and other embodiments of the present invention, the controller, or a sensor working with the controller, can track the position of the user. This tracking can then be used to track where the characters should be rendered. The tracking can also be used in remapping the controls.

Various embodiments of the present invention can incorporate one or more of these and the other features described herein. A better understanding of the nature and advantages of the present invention can be gained by reference to the following detailed description and the accompanying drawings.

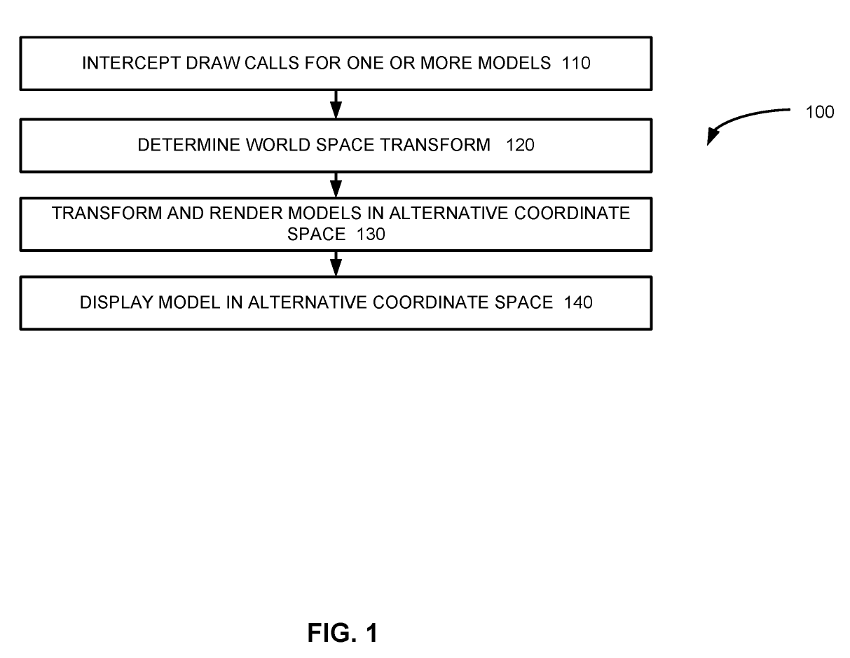

FIG. 1 illustrates a method of displaying characters in a game according to an embodiment of the present invention. In act 110 of method 100, specific API calls, like Graphics API Draw calls (referred to from here simply as draw calls for brevity), draw call information, and related commands and data for one or more 3D models or other 3D visual data, 2D models or other 2D visual data, audio and haptic data or other game assets (collectively referred to here simply as models or 3D models for brevity) can be intercepted from the output of a game program, for example in an API of a GPU. Draw call information and related data and commands for 3D models can be intercepted from a graphics API, while draw call information and related commands and data for other 3D models can be ignored.

The draw call information and related data and commands can include different types of data. For example, vertices, indices, textures, shaders, shader parameters, and other graphics data can be included. In addition, 3D model data, 2D visual data, audio and haptic data can be included.

A world space transform can be determined in act 120. That is, it can be determined how to transform from game coordinate space to an alternative coordinate space. In act 130, the 3D models can be transformed and rendered in the alternative coordinate space. The transformed 3D models can be displayed in the alternative coordinate space in act 140.

In one example, a physical area where a user is playing can be read using a virtual reality/augmented reality headset and used as the alternative coordinate space. The 3D models can be intercepted from a game, transformed from the game space to an alternative coordinate space, and then rendered and displayed in the alternative coordinate space. Where the display is a headset, the physical area around the user can be seen using a pass-through mode on the headset and 3D models can be transformed into the headset’s coordinate space that is the real-world image and then rendered and displayed. This can provide an immersive gaming experience where a user can operate a model in a living room or other physical area. Embodiments of the present invention can accomplish this without changes to the underlying game program.

In this example, a physical space around a player can be used as an alternative coordinate space into which 3D models can be transformed and rendered. In these and other embodiments of the present invention, other alternative coordinate spaces can be used, where an alternative coordinate space is a space that is not the original game world space. For example, a space from a game can be used as an alternative coordinate space. The game can be a different game from which the 3D models are extracted. A different physical space that the player is remote from can be used as an alternative coordinate space. Virtual spaces modeled from historical locations can be used as alternative coordinate spaces. Other virtual or real spaces can be used as the alternative coordinate space and the models can be transformed and rendered into that space.

In these and other embodiments of the present invention, one or more of a server, console, and headset (or other display unit) can execute various tasks. The tasks can include generating draw call information and other data for 3D models, rendering the 3D models, and displaying the 3D models in an alternative coordinate space. Again, a player using an augmented or virtual-reality headset, tablet, smartphone, handheld gaming device or any other spatial device that is aware of its spatial location and direction in the real world and can be used to play video games, can view the rendered 3D models in the alternative coordinate space. When the alternative coordinate space is a physical space around the player, the displayed images can provide a very immersive experience.

In a first example, in the system shown in FIG. 2, a game program 263 running on a central processing unit (CPU) 262 in servers 250 can intercept draw call information and other data and commands, including those for a set of one or more 3D models. Servers 250 can send the draw call information and other data and commands for the set of one or more 3D models to console 210 and can omit from sending draw call information that is for 3D models not in the set of one or more 3D models. Console 210 can receive the draw call information and other data and commands for the set of 3D models from server 250 over network 270 and can render the 3D models. The set of 3D models can be sent to headset 220 and transformed to a coordinate space of headset 220, which can be the physical environment or other alternative space around player 202 and then rendered and displayed.

In a second example, in the system shown in FIG. 2, servers 250 can intercept draw call information and other data and commands using a game program, including those for a set of one or more 3D models. Servers 250 can send the draw call information and other data and commands for a set of one or more 3D models to headset 220 and can omit from sending draw call information that is for 3D models not in the set of one or more 3D models. Headset 220 can include GPU 282. Headset 220 can receive the draw call information and other data and commands for the set of one or more 3D models from the server over network 270. The 3D models can be transformed to an alternative coordinate space, which can be the physical environment around player 202 or other alternative coordinate space and rendered and displayed on a screen of headset 220.

In a third example, in the system shown in FIG. 5, console 210 can intercept draw call information and other data and commands for a game program, including those for a set of one or more 3D models. Console 210 can transform and render the set of one or more 3D models and send them over a Wi-Fi or other network 570 to headset 220. Headset 220 can then display the set of 3D models in the headset’s coordinate space, which can be the physical environment around player 202 or other alternative coordinate space and displayed on a screen of headset 220.

In a fourth example, in the system shown in FIG. 5, console 210 can intercept draw call information and other data and commands for a game program, including those for a set of one or more 3D models. Console 210 can send the draw call information and other data and commands for the set of one or more 3D models to headset 220. Console 210 can omit sending draw call information that is for 3D models not in the set of one or more 3D models. Headset 220 can include GPU 582. Headset 220 can receive the draw call information and other data and commands for the set of 3D models from server 250 over network 570 and render the 3D models. The 3D models can be transformed to the coordinate space of the headset, which can be the physical environment around player 202, and then rendered and displayed on a screen of headset 220, which can be the physical environment around player 202 or other alternative coordinate space.

FIG. 2 illustrates a gaming system according to an embodiment of the present invention. Gaming system 200 can include console 210, headset 220, controller 230, and servers 250. Servers 250 can include a server running on a consumer console, a phone, or any device capable of carrying out the methods described. Console 210, headset 220, and controller 230 can be at a first location, such as a user’s house, while servers 250 can be at a remote cloud computing or data center. In this example, monitor or television 240 can be included. While player 202 might not use television 240, with proper connections others in the room can view what player 202 is seeing on headset 220.

Again, in a first example, server 250 can intercept draw call information and other data and commands for one or more 3D models. That is, game program 263 can generate draw call information and related commands and data for rendering the models. Draw call information and related commands and data for 3D models can be intercepted and transmitted to console 210, while other draw call information and related commands and data are not transmitted to reduce network bandwidth, that is, the other draw call information and related commands and data can be ignored. Console 210 can receive draw call information and other data and commands for 3D models from server 250 over network 270. The draw call information and other data and commands can be sent to headset 220 and transformed to the coordinate space of the headset, which can be the physical environment around player 202, and then rendered and displayed.

In a second example, server 250 can intercept draw call information and other data and commands for one or more 3D models. Headset 220 can include a GPU. Headset 220 can receive the draw call information and other data and commands for the 3D models from server 250 over network 270. The draw call information and other data and commands can be transformed to the headset’s coordinate space, which can be the physical environment around player 202, and then rendered and displayed.

More specifically, servers 250 can include server circuits 260. Server circuits 260 can include CPU 262 that runs a game program 263. Conventionally, game program 263 can provide initial model information and updates to the positions of the 3D models to API 264, which can pass data to GPU 266, which can render the game with rendering engine 267.

In these and other embodiments of the present invention, the data passed from game program 263 in CPU 262 to API 264 can be intercepted in API 264 by intercept circuit 268. Intercept circuit 268 can detect initial model information and model updates for 3D models and can forward them through network 270 from servers 250 in the data center to client circuits 280. Other 3D models that are not of interest can be ignored. GPU 282 can use rendering engine 283 to render the initial model information and model updates for the 3D models for display to user on headset 220. Player 202 can play the game by manipulating controls on controller 230. Controller 230 can send signals to client circuits 280, which can pass them back through network 270 to server circuits 260, though the components for this path have been omitted for clarity.

In this example, data in API 264 of server circuits 260 can be intercepted by intercept circuit 268. This provides an advantage in that game program 263 does not need to be modified. That is, game program 263 can generate game data without interruption and intercept circuit 268 can gather the data that it needs in API 264 and then provide it to a client for rendering.

In these and other embodiments of the present invention, intercept circuit 268 can be implemented in various ways. For example, intercept circuit 268 can be implemented on GPU 266, the graphics pipeline of GPU 266, API 264, or elsewhere. Intercept circuit 268 can be a hardware circuit, software, firmware, or a combination of these.

In these and other embodiments of the present invention, GPU 266 and rendering engine 267 can be reallocated to other tasks since they might not be needed. Also, instead of intercepting draw call information in API 264, the graphics data bus coming into API 264 can be snooped and draw call information and related commands and data can be copied and send over network 270 to client circuits 280.

Also, in these and other embodiments of the present invention, instead of relying on intercepting or snooping draw call information, the game program can include code for providing draw call information directly to network 270 to be send to client circuits 280. This can simplify the design of server circuits 260 since intercept circuit 268 does not need to analyze data in API 264.

Client circuits 280 can be located in different devices in these and other embodiments of the present invention. For example, headset 220 can primarily act as a screen for console 210 and GPU 282 and rendering engine 283 can be located in console 210. In this case, console 210 can receive initial model information and model updates over network 270. Console 210 can provide graphics information wirelessly to headset 220. Alternatively, console 210 can provide graphics information over a wired connection to headset 220.

In another example, headset 220 can include client circuits 280 and console 210 can be bypassed. Model information and model updates can be received from server circuits 260 over network 270 directly by headset 220. Headset 220 can connect to server circuits 260 over network 270. Headset 220 can process the received graphics information and transform and render the 3D models and their updates using GPU 282 and rendering engine 283. Rendering engine 283 can then display the graphics image on a screen in headset 220.

In these configurations, player 202 can typically see the room they are standing in using the headset’s pass-through mode. GPU 282 and rendering engine 283 can render the one or more 3D models intercepted by intercept circuit 268 and overlay them in the pass-through view seen on the headset. This essentially puts the modeled game characters in the player’s room along with the user, thereby providing an immersive experience.

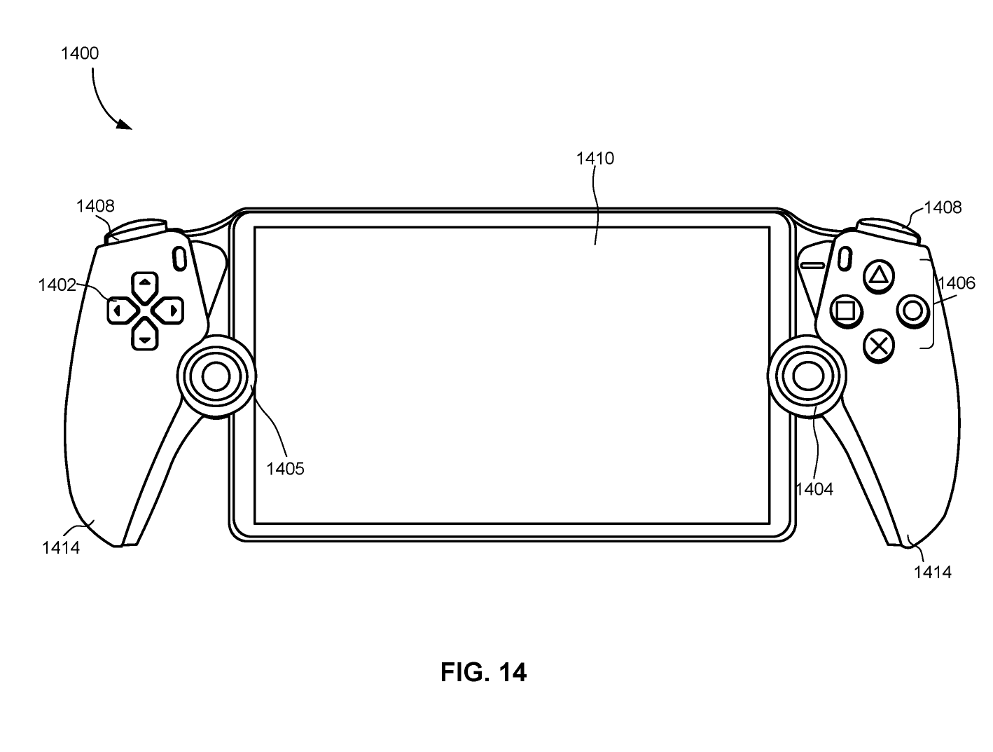

In still another example, headset 220 can be replaced by handheld device 1400 (shown in FIG. 14) that can include features from controller 230 along with a screen. As before, client circuits 280 can be located in different devices in these and other embodiments of the present invention. For example, handheld device 1400 can primarily act as a screen for console 210 and GPU 282 and rendering engine 283 can be located in console 210. In this case, console 210 can receive initial model information and model updates over network 270. Console 210 can provide graphics information wirelessly to handheld device 1400. Alternatively, console 210 can provide graphics information over a wired connection to handheld device 1400.

In another example, handheld device 1400 can include client circuits 280 while console 210 can be bypassed. Model information and model updates can be received over network 270 directly by handheld device 1400. Handheld device 1400 can connect to server circuits 260 over network 270. Handheld device 1400 can process the received graphics information and render the 3D models and their updates using GPU 282 and rendering engine 283. Rendering engine 283 can then display the graphics image on a screen in headset 220.

In these configurations, handheld device 1400 can include a camera (not shown.) The camera can provide an image of where it is pointed in the room on touchscreen 1410 (shown in FIG. 14.) GPU 282 and rendering engine 283 can render the one or more 3D models intercepted by intercept circuit 268 and overlay them in the image captured by the camera and displayed by the screen. This essentially puts the modeled game characters in the player’s room, thereby providing an immersive experience.

In these and other embodiments, different headsets, handheld gaming devices, and other devices can be used. An illustrative embodiment of the present invention can extract one or more assets from a video game in real time and render them in a single consistent space for consuming using an augmented or virtual-reality headset, tablet, smartphone, handheld gaming device, or any other spatial device that is aware of its spatial location and direction in the real world and that can be used to play video games.

In these and other embodiments of the present invention, instead of being intercepted, draw call information and other commands and data for the 3D models can be snooped enroute from CPU 262 to API 264. Once the draw call information and other commands and data for the 3D models are snooped, they can be copied and sent to a client over network 270. In these and other embodiments of the present invention, the images rendered by rendering engine 267 might not be of use. Whether the draw call information is intercepted or snooped, the draw call information can be rerouted such that they do not reach the GPU 266 and rendering engine 267. As a result, these circuits might be at least partially powered down. An example where intercept circuit 268 intercepts draw call information for one or more 3D models in a set of 3D models and provides them to network 270 is shown in the following figure.

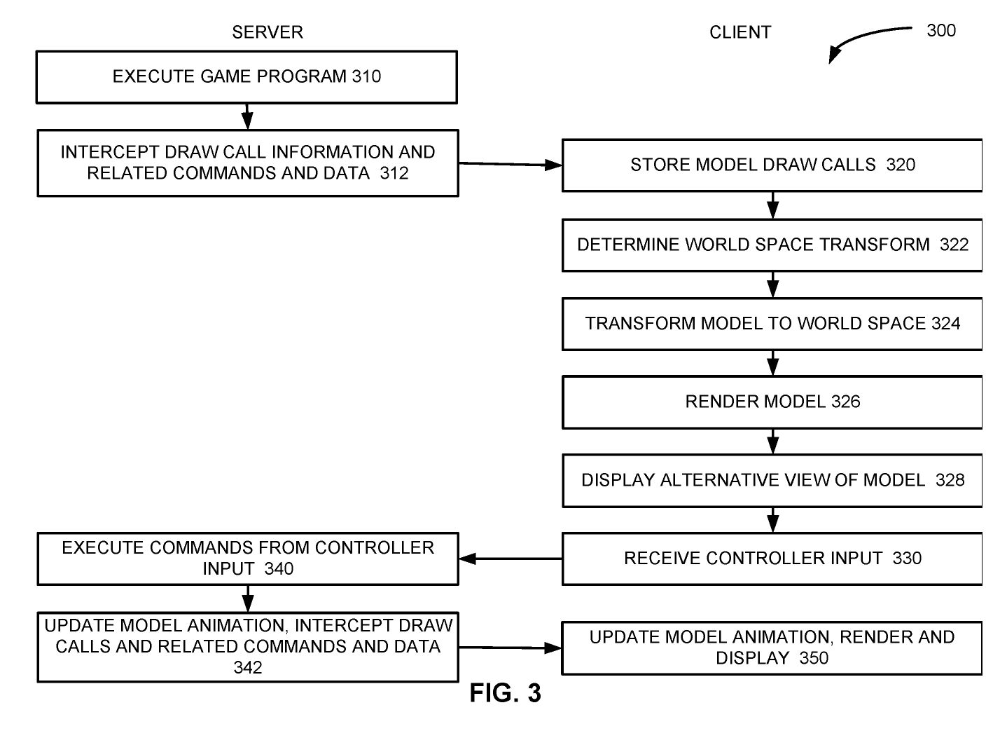

FIG. 3 illustrates a method of operating a gaming system according to an embodiment of the present invention. In flowchart 300, a server can execute a game program in act 310. The game program can generate draw call information for one or more 3D models in a model space. In act 312, the draw call information and related commands and data for 3D models that are being extracted can be intercepted and sent to a client device. The draw call information and related commands and data for 3D models that are not being extracted can be ignored.

Draw call information and related commands and data for the 3D models can be stored at the client in act 320. In act 322, an area around a player can be mapped and stored as the headset’s coordinate space, for example using a headset such as headset 220. The 3D models can be transformed into the pass-through view of the alternative coordinate space in act 324. That is, the 3D models can be placed so that they appear in logical places in pass through view. For example, a character’s feet can be aligned with the floor, the characters can be a distance from a wall, they can be positioned such that normal game play tends to avoid interactions with real-world objects, and the like. The 3D models for the characters can then be rendered in the pass-through view in act 326 and displayed in act 328.

In act 330, a player can move a controller input. As an example, a player might want their character to move to left. The resulting commands can be sent to the server and executed by the game program in act 340. The model animation information including position can be updated by the server as part of the game program execution in act 324. The updated information for the model can be snooped and sent to the client in act 342 and displayed by the client in act 350.

In this example, draw call information and other commands and data can be intercepted in the API input or other location and passed to a client. This can allow embodiments of the present invention to be executed without any changes to the game program. This is particularly useful with older games. But newer game programs can include code that can provide draw call information and other commands and data to a client device over a network. In this case, each command and data from the CPU to an API does not need to be analyzed. This can help to reduce latency and reduce power consumption. An example is shown in the following figure.

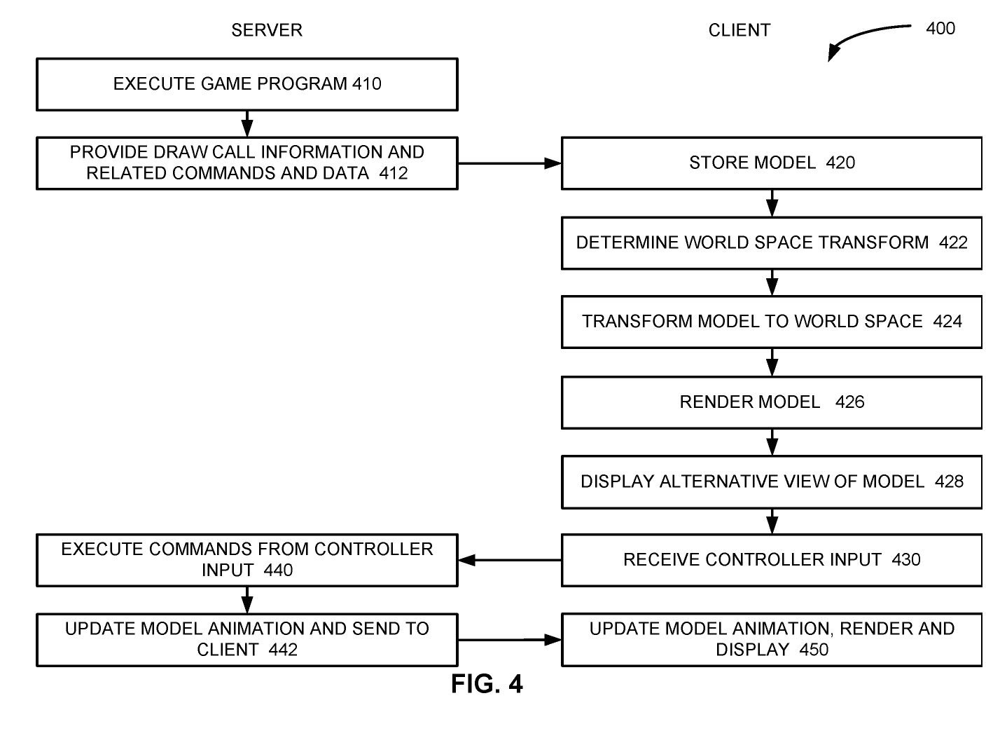

FIG. 4 illustrates a method of operating a gaming system according to an embodiment of the present invention. In this example, draw call information and related commands and data do not need to be intercepted. Instead, the game program can segregate the draw call information and related commands and data for 3D models that are being extracted and provide them to a client.

Specifically in flowchart 400, a server can execute a game program in act 410. The game program can generate one or more 3D models in a model space. Draw call information and related commands and data for the 3D models can be sent to a client device. That is, draw call information for 3D models or other images that will be rendered in an alternative coordinate space can be provided and sent to a client device, whereas other draw call information and related commands and data for 3D models that are not being extracted are not sent to the client device.

Draw call information and other information for the 3D models can be stored at the client in act 420. In act 422, an area around a player can be mapped and stored as the headset’s coordinate space, for example using a headset such as headset 220 (shown in FIG. 2.) The 3D models can be transformed and rendered in the pass-through view of the headset’s coordinate space in act 424. That is, the 3D models can be rendered so that they appear in logical places in pass-through view. Character’s feet can be aligned with the floor, the characters can be a distance from a wall, the characters can be positioned such that normal game play tends to avoid interactions with real-world objects, and the like. The 3D models for the characters can then be rendered into the pass-through view in act 426 and displayed in act 428.

In act 430, a player can move a controller input. As an example, a player might want their character to move to left. The resulting commands can be sent to the server and executed by the game program in act 440. The model animation information including position can be updated by the server as part of the game program execution in act 424. The updated information for the model can be provided to the client in act 442 and displayed by the client in act 450.

In these and other embodiments of the present invention, console 210 (shown in FIG. 2) can execute a game program, detect draw call and related commands and data for the 3D models, and then the 3D models can be rendered for insertion into alternative coordinate space as seen by a player. An illustrative system and method are shown in the following figures.

FIG. 5 illustrates a gaming system according to an embodiment of the present invention. Gaming system 500 can include console 210, headset 220 and controller 230. Console 210, headset 220, and controller 230 can be at a first location, such as a user’s house. In this example, monitor or television 240 can be included. While player 202 might not use television 240, with proper connections others (not shown) in the room can view what player 202 is seeing on headset 220.

Again, in a first example, console 210 can intercept draw call information and other commands and data for one or more 3D models. Console 210 can transform and render 3D models and send them over a Wi-Fi or other network 570 to headset 220. Headset 220 can then display the 3D models in the real-world view that is seen in the pass-through mode of headset 220. In a second example, console 210 can generate draw call information and other commands and data for one or more 3D models. Headset 220 can include a GPU. Headset 220 can receive the draw call information and other data and commands for 3D models from server 250 over network. The 3D models can be transformed to the headset’s coordinate space, which can be the physical environment around player 202, and then rendered and displayed on a screen of the headset 220.

More specifically, console 210 can include console circuits 560. Console circuits 560 can include CPU 562 that runs game program 563. Game program 563 can provide graphics data to API 564 on the graphics bus. In the first example, intercept circuit 568 can route draw call information and related commands and data for 3D models to GPU 566 and rendering engine 567, which can generate the 3D models and send them from API 564 over network 570 to headset 220 or other display. In the second example, intercept circuit 568 can reroute the draw call information and related commands and data for 3D models to headset 220 over network 570, and headset 220 can render the 3D models for display using GPU 582 and rendering engine 583.

That is, in the first example, the data passed from game program 563 in CPU 562 to API 564 can be intercepted in API 564 by intercept circuit 568. Intercept circuit 568 can detect initial model information and model updates for the models being extracted and can forward them to GPU 566. GPU 566 can use rendering engine 567 to render the initial model information and model updates for display to user on headset 220. In the second example, intercept circuit 568 can reroute draw call information and related commands and data from API 564 to headset 220 via network 570. In this case, GPU 566 and rendering engine 567 can be at least partially powered down as they might not be needed since headset 220 is rendering the characters. In both examples, player 202 can play the game by manipulating controls on controller 230. Controller 230 can send signals to console circuits 560, though the components for this path have been omitted for clarity.

In this example, data at API 564 of console circuits 560 can effectively be snooped. This provides an advantage in that game program 563 does not need to be modified. That is, game program 563 can generate game data without interruption and intercept circuit 568 can gather the data that it needs at API 564 and then provide it to either GPU 566 or GPU 582.

GPU 582 and rendering engine 583 can be located in different devices in these and other embodiments of the present invention. For example, headset 220 can be used primarily as a screen for console 210 and GPU 582 and rendering engine 583 can be omitted. Alternatively, GPU 582 and rendering engine 583 can be located headset 220. Console 210 can provide the rendered graphics information wirelessly over network 570 to headset 220. Alternatively, console 210 can provide graphics information over a wired connection to headset 220. Network 570 can be Ethernet, Wi-Fi, Bluetooth, or other type of wired or wireless network. Headset 220 can process the received graphics information and render the 3D models and their updates using GPU 582 and rendering engine 583. Rendering engine 583 can then display the graphics image on a screen in headset 220.

In these configurations, player 202 can typically see the room they are positioned in using the headset’s pass-through mode, which can be the headset’s alternative coordinate space. GPU 566 and rendering engine 567, or GPU 582 and rendering engine 583, can render the one or more 3D models intercepted by intercept circuit 568 and overlay them in the pass-through view seen on the headset. This essentially puts the modeled game characters in the player’s room along with the user, thereby providing an immersive experience.

In still another example, headset 220 can be replaced by handheld device 1400 (shown in FIG. 14) that can include features from controller 230 along with a screen. As before, GPU 582 and rendering engine 583 can be located in different devices in these and other embodiments of the present invention. For example, handheld device 1400 can primarily act as a screen for console 210 and GPU 566 and rendering engine 567 can be omitted. In this case, console 210 can generate initial model information and model updates. Console 210 can send the model information and model updates to headset 220, where they can be rendered and displayed. Console 210 can provide graphics information wirelessly to handheld device 1400. Alternatively, console 210 can provide graphics information over a wired connection to handheld device 1400.

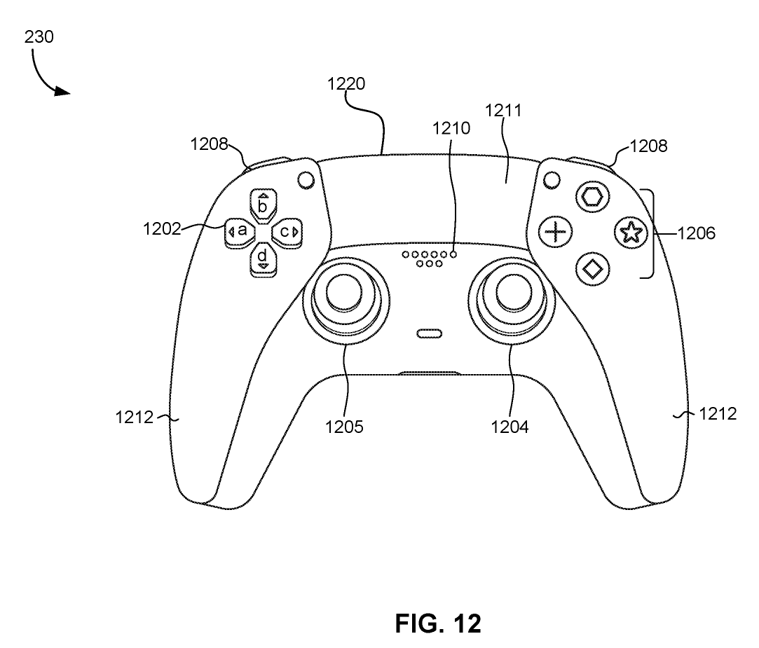

In another example, handheld device 1400 can include GPU 582 and rendering engine 583, while GPU 566 and rendering engine 567 in console 210 can be bypassed. Model information and model updates can be received over a wired or wireless network by handheld device 1400. The network can be wired or wireless. The network can be Ethernet, Wi-Fi, Bluetooth, or other type of wired or wireless network. Handheld device 1400 can process the received graphics information and render the 3D models and their updates using GPU 582 and rendering engine 583. GPU 582 can then display the graphics image on touchscreen 1410 (shown in FIG. 12) of handheld device 1400.

In these configurations, handheld device 1400 can include a camera (not shown.) The camera can provide an image of where it is pointed in the room on touchscreen 1410. GPU 566 and rendering engine 567 (or GPU 582 and rendering engine 583) can render the one or more 3D models intercepted by intercept circuit 268 and overlay them in the image captured by the camera and displayed by the screen. This essentially puts the modeled game characters in the player’s room, thereby providing an immersive experience.

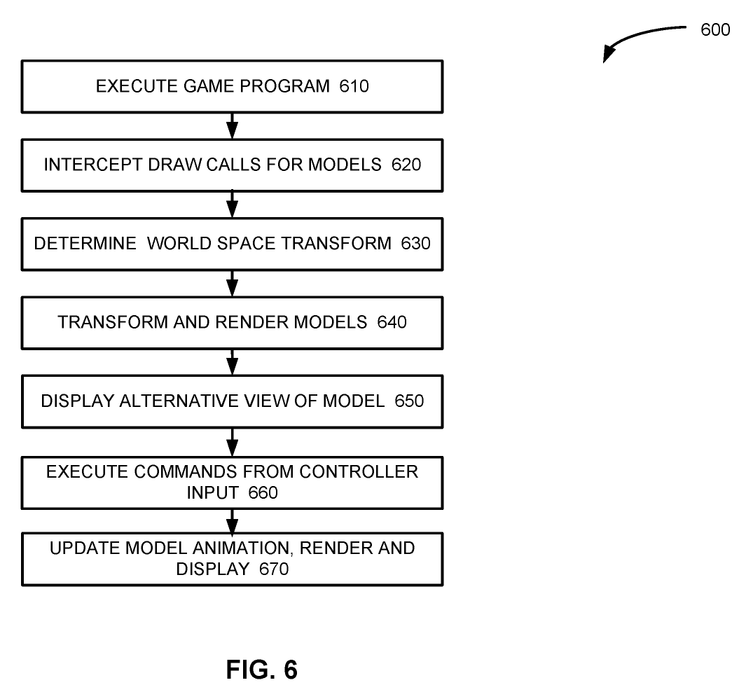

FIG. 6 illustrates a method of operating a gaming system according to an embodiment of the present invention. In act 610, a game program can be executed, for example on a console 210 (shown in FIG. 2.) In act 620, draw call information for 3D models can be intercepted. The draw call information and related commands and data can be generated by a CPU, such as CPU 562. The draw call information and related commands and data for the 3D models can be output by CPU 562. The draw call information and related commands and data for 3D models, that is, for those 3D models being extracted, can be forwarded for rendering either in console 210, headset 220, or other device. The draw call information and related commands and data for 3D models that are not being extracted can be ignored.

A headset’s coordinate space can be read in act 630. For example, headset 220 can be used to map out room where player 202 is located. Once the room is mapped the 3D models can be transformed into the headset’s coordinate space of the room and rendered in act 640. During this transformation, a character’s virtual feet can be aligned with the real-world floor, the characters can be a distance from a wall, they can be positioned such that normal game play tends to avoid interactions with real-world objects, and the like. The 3D models for the characters can then be overlayed on the pass-through view and displayed in act 650.

In act 660, a user can execute commands with a controller. The model animation can be updated and the new positions of the characters can be displayed in act 670.

Again, embodiments of the present invention can extract 3D models for characters in a game and render them in a pass-through mode on a virtual reality/augmented reality headset or other display device. An example is shown in the following figure.

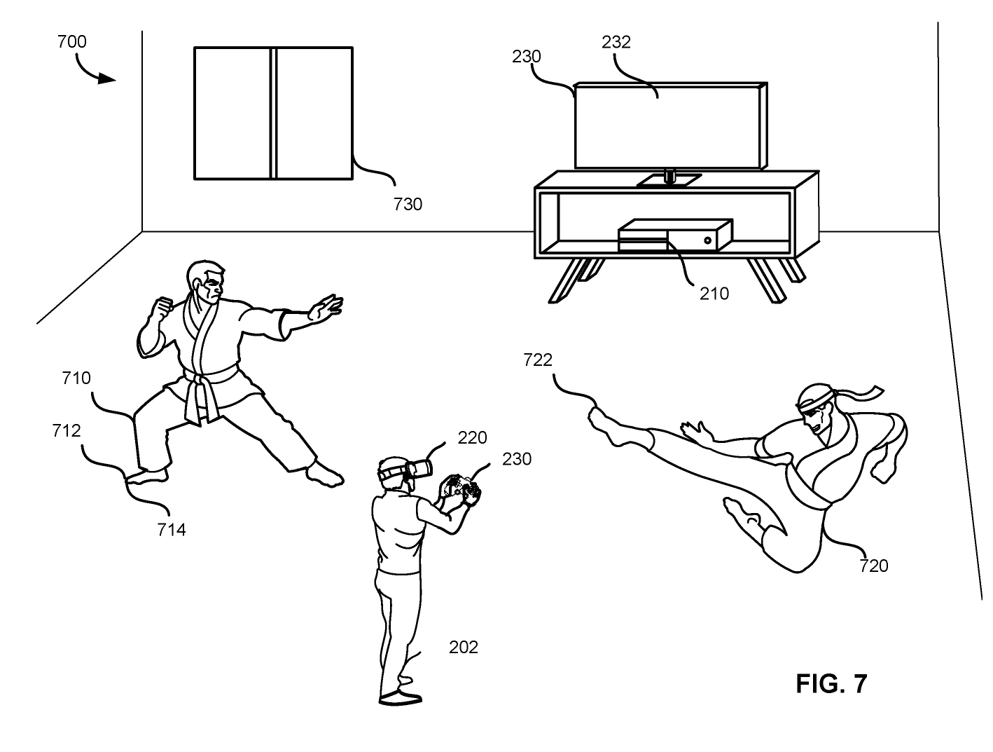

FIG. 7 illustrates gameplay provided by an embodiment of the present invention. In this example, player 202 can see room 700 in pass-through mode on headset 220. Console 210, television 240, and window 730 can be real-world objects that player 202 can see in pass-through mode.

In this example, a pass-through mode is described as providing the alternative coordinate space. In these and other embodiments of the present invention, other alternative coordinate spaces can be used, where an alternative coordinate space is a space that is not the original game world space. For example, a space from a game can be used as an alternative coordinate space. The game can be a different game from which the 3D models are extracted. A different physical space that the player is remote from can be used as an alternative coordinate space. Virtual spaces modeled from historical locations can be used as alternative coordinate spaces. Other virtual or real spaces can be used as the alternative coordinate space and the models can be transformed and rendered into that space.

A combination of servers 250 (shown in FIG. 2), console 210, and headset 220 can render 3D models for character 710 and character 720 in a manner described above or otherwise provided for by an embodiment of the present invention. Character 710 can be positioned in room 700 by aligning a reference point on character 710, such as reference point 712, to a point on the floor, such as point 714. Character 720 can similarly be placed relative to the floor, or character 720 can be placed relative to the character 710. For example, reference point 712 on character 710 can also be used to located character 720. Other 3D models generated by the game program, such as those for ceilings, walls, and the like, might not be rendered can be ignored.

In this example, player 202 can view physical objects in room 700 along with virtual character 710 and virtual character 720 using headset 220. Player 202 can control character 720 with controller 230. Controller 230 can include one or more controls for controlling a direction of movement for character 720. For example, player 202 can push joystick 1205 to the left to have character 720 move to the left. Player 202 can instead use the left pad on D-pad 1202 to move character 720 to the left. In some games, player 202 can instead tilt controller 230 to the left to move character 720 to the left. In some games, player 202 instead look to the left to move character 720 to the left.

To provide an even more immersive experience, player 202 can move in room 700. This movement can change the view from the perspective of player 202. That is, player 202 can view objects like television 240 and window 730 from different perspectives. In this example, character 710 is rendered relative to floor point 714 and character 720 is rendered relative to point 712 of character 710. As a result, player 202 can move relative to character 710 and character 720. But this can cause confusion when player 202 tries to move character 720. For example, pushing joystick 1205 to the left or using the left pad on D-pad 1202 might not result in character 720 moving left relative to player 202. This is further elaborated upon in the next two figures.

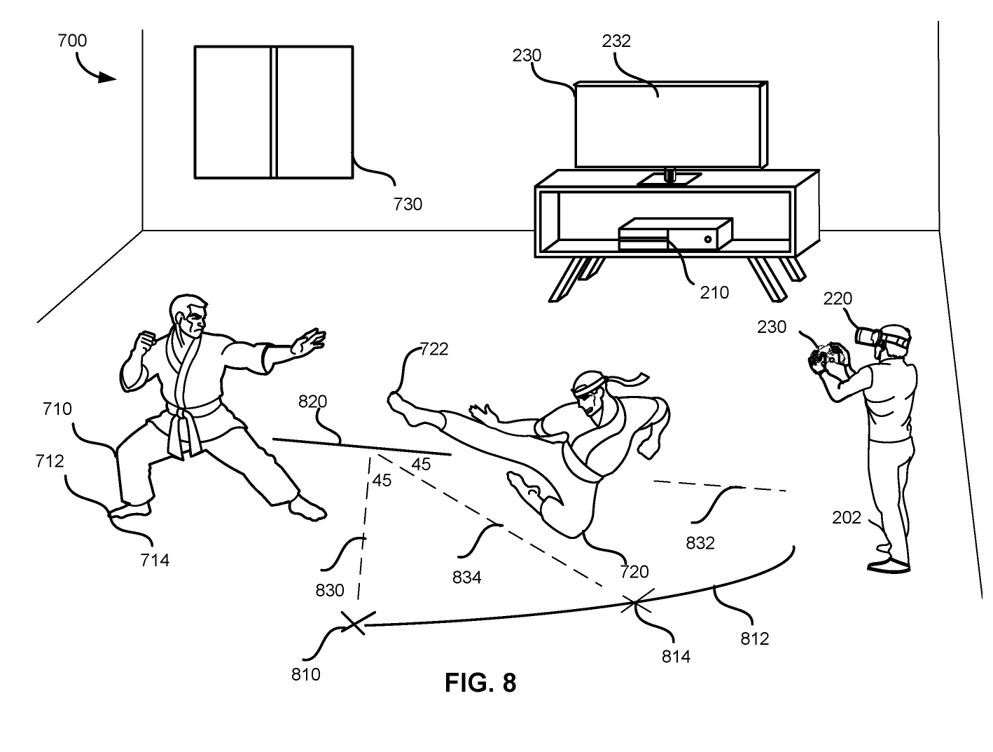

FIG. 8 illustrates additional gameplay provided by an embodiment of the present invention. In this example, player 202 has moved to the right from point 810 along arc 812 to their present location. Player 202 is roughly aligned with character 710 and character 720. More specifically, if line 820 forms a line between character 710 and character 720, player 202 began at a location viewing line 820 from an orthogonal direction (as shown by dashed line 830) and has now moved to be aligned with line 820 (as shown by dashed line 832.) That, is, player 202 has moved 90 degrees relative to character 710 and character 720.

In this position, pushing joystick 1205 to the left or using the left pad on D-pad 1202 on controller 230 can result in character 720 moving away from player 202, instead of moving to the left of player 202 as might be expected. Similarly, when player 202 pushed joystick 1205 up or uses the up (top) pad on D-pad 1202 on controller 230, character 720 can move to the player’s right, if allowed to by the game. If the game does not provide for three-dimensional movement, pushing joystick 1205 up or using the up (top) pad on D-pad 1202 on controller 230 might result in no action.

Accordingly, embodiments of the present invention can update the controls on controller 230 as player 202 moves through room 700. These controls can be varied in different ways. In one embodiment, the controls can stay in the state they have at a start and not remap. In another embodiment, the controls can remap when player 202 moves more than 90 degrees from their original position at power up. In another embodiment, the controls can remap when player 202 moves more than 45 degrees from their original position at power up. In other embodiments, the controls can remap when player 202 moves other amounts relative to an original position. In other embodiments, the controls can remap in a continuous manner as player 202 moves relative to character 710 and character 720.

In one example, a player can begin a game at point 810 such that they are orthogonal to line 820 between character 710 and character 720 (as shown by dashed line 830.) In this state, a first function can be mapped to a control, such as joystick 1205 or D-pad 1202. With the first function, when player 202 pushes or moves joystick 1205 left or presses the left pad on D-pad 1202 on controller 230, character 720 can move to the player’s left, as expected. When player 202 moves through arc 812 more than 45 degrees from point 810 to point 814 (as indicated by dashed line 834), the control can remap by 90 degrees. That is, a second function can be mapped to the control. In this case, when player 202 reaches the position shown in this figure, pushing joystick 1205 up or pressing the top pad on D-pad 1202 on controller 230 can result in character 720 moving away from player 202, again as expected.

The movement of player 202 can be tracked in various ways such that the controls on controller 230 can be remapped. In these and other embodiments of the present invention, headset 220 can be used, or used in conjunction with either or both servers 250 (shown in FIG. 2) and console 210, to track the locations of structures in room 700, such as television 240 and window 730 to determine movements by player 202. Sensors such as gyroscopes and the like in controller 230 and headset 220 can also be used.

In these and other embodiments of the present invention, a direction in which player 202 is viewing character 710 and character 720 can be used to track movement of player 202 in remapping controls on controller 230. For example, if player 202 is looking towards the right of window 730 for a first duration, the gaming system can determine that player 202 is near point 810. When player 202 is looking towards the wall adjacent the left of window 730 for a first duration, the gaming system can determine that player 202 is near their present location as shown.

In these and other embodiments of the present invention, a rotational position of either or both controller 230 and headset 220 can be used to determine a position of player 202 relative to line 820. The rotational position of controller 230 or headset 220 can be used to estimate a rotational position of player 202 relative to line 820. This information can then be used to remap the controls of controller 230.

In these and other embodiments of the present invention, either or both controller 230 and headset 220 can include an absolute position sensor. Such a sensor can include linear and rotational sensors to track movement of controller 230 or headset in room 700. This absolute position sensor can determine an actual position of player 202 for use in remapping controls of controller 230.

Various types of games can be used with embodiments of the present invention. In this example, the game can be a two character combat game where player 202 controls the actions of character 720 and character 710 is an NPC (non-player character), a character controlled by another player, or other type of character. While embodiments of the present invention are well-suited to use with combat or fighting games, other types of games can incorporate or be improved by embodiments of the present invention. For example, adventure games, platformers, sports, couch-cooperatives, puzzle, racing, first-person shooter, educational, role-playing games (including action and Japanese role playing games), and others, can incorporate or be improved by embodiments of the present invention.

Various 3D models can be extracted from a game and sent to a client device for display. For example, in the fighting game of this example, 3D models for one or more combatants can be extracted and rendered in an alternative coordinate space. Such a game is entertaining and works well with embodiments of the present invention. That is, only a limited amount of model data might need to be transferred initially, and the amount of data to be transferred during game play for updates can be reduced. In such a game, 3D models that can be used by character 720 and character 710, such as boxing gloves, protective gear, or other handheld or wearable objects, as well as other 3D models, can be sent with the initial data and updated as the game progresses.

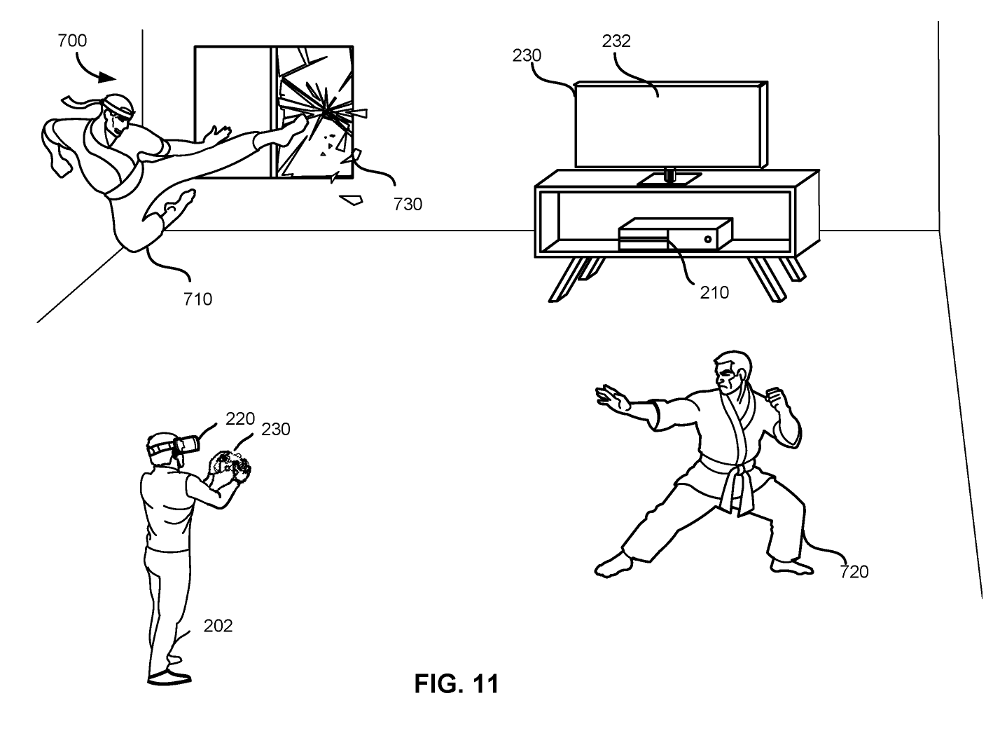

Applying embodiments of the present invention to a fighting game can provide various advantages. For example, in an illustrative embodiment of the present invention, 3D models for character 710 and character 720 can be extracted from the game and placed in an alternative coordinate space corresponding to a user’s physical environment using an augmented-reality device, such as headset 220. In the fighting game, only character 710 and character 720 themselves and objects that they interact with might need to be initially transferred and updated. That is, only a limited number of 3D models, for example only 3D models for the two character combatants, might need to be initially transferred and later updated since each character can interact with the other. Additional 3D models for items the combatants might use can be initially transferred and later updated as well. Other 3D models that are not interacted with by the combatants can be omitted, though some exceptions can be made as shown in FIG. 11. Conversely, games where characters interact with other items in a scene, such rocks, hills, plants, walls, doors, and the like, can increase the amount of data transferred during a game.

Another advantage of utilizing an embodiment of the present invention on a fighting game might be that the fighting game happens in a linear space. When played conventionally, the game program might provide a two-dimensional space for character 710 and character 720 where they fight moving along a single axis, such as from left to right. As such, the game program “camera” can conventionally provide a view as if the camera were on a rail that limits the point-of-view to two dimensions, even though the characters themselves can appear to be three-dimensional.

When rendered in accordance with an embodiment of the present invention, character 710 and character 720 can be limited to move along line 820 in room 700. This limitation can facilitate the transformation of the fighting characters into the alternative coordinate space that is the physical room 700. Such a limited movement for character 710 and character 720 can make it easier for the characters to be positioned to avoid obstacles such as furniture and walls, such as television 240 in this example.

In some circumstances, the available space in room 700 might be less than what is needed by the game program. Also, where fighting characters can move in additional dimensions (front-to-back, up and down), more data might need to be transferred, and it might be more difficult to confine the character positions and movements to avoid real-world obstacles. Accordingly, embodiments of the present invention can adjust the relative position of the characters in real space. That is, instead of placing character 710 and character 720 5 meters apart, they can be rendered to be 2 meters away from each other. Also, the relative velocities with which character 710 and character 720 move towards and away from each other can be varied to compensate for this change in spacing. As an example, in game space, the characters can begin 6 meters apart and move to close the gap to 3 meters in 1 second, for a velocity of 3 meters per second. To reduce the real-world area needed, character 710 and character 720 can be rendered to begin at 4 meters apart and move to close the gap to 2 meters in 2 seconds, for a reduced velocity of 2 meters per second. This can help to maintain a logical position between rendered characters in a reduced area.

Character 710 and character 720 can be rendered in an alternative coordinate space that is an area around a game player, for example room 700. That is, one or more characters can be rendered in an alternative coordinate space that is the physical space that can be seen by the game player using headset 220 in the pass-through mode. Where headset 220 is used, the area around a user can be mapped during an initialization period. Character 710 and character 720 can then be rendered into this mapped space. Where it is known that the combatants can move in different directions an equal amount, character 710 and character 720 can be positioned towards the middle of the available area. Where it is known that that the combatants have more range in a first direction, the combatants can be positioned away from the middle of the available area to provide more range for movement in the first direction. This can further help to avoid obstructions in the real world as seen by player 202.

Again, one or more controls on controller 230 can be remapped as player 202 moves around the room relative to character 710 and character 720. In short, as player 202 moves counterclockwise relative to character 710 and character 720, the control can be remapped in a clockwise direction. An example is shown in the following figure.

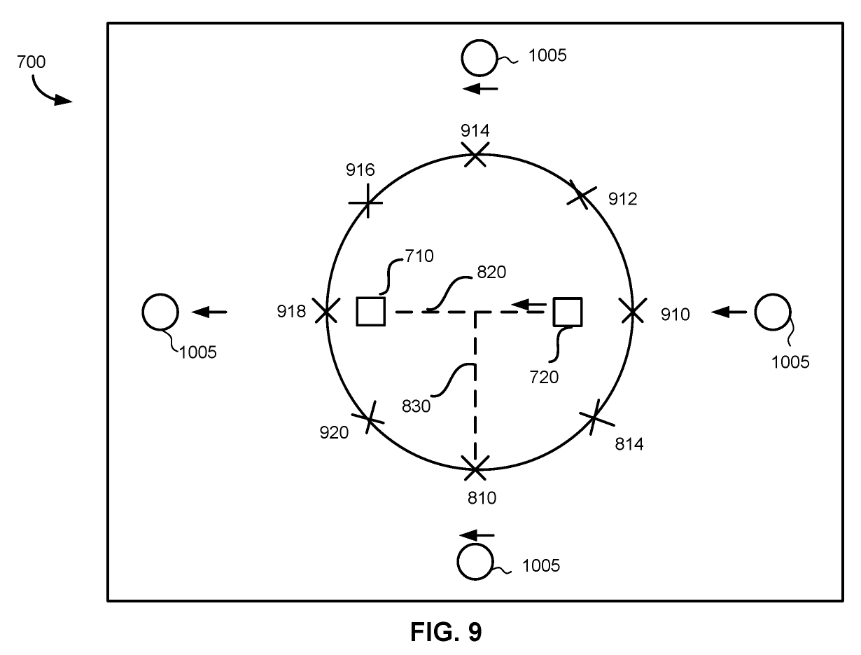

FIG. 9 illustrates a method of remapping a control to compensate for movement of a player during a game. In this example, character 710 and character 720 are constrained to move along line 820. Player 202 (shown in FIG. 8) can begin at origin point 810 such that player 202 is looking towards the top of the page as shown. A line 830 from player to line 820 can be orthogonal. When player 202 controls character 720 and wants character 720 to move to the left from the point of view of player 202, player 202 can tilt joystick 1205 to the left as shown.

As player 202 moves through an arc of 90 degrees, player 202 can arrive at point 910. At this time, player 202 can be looking to the left of the page as drawn. Here joystick 1205 can be remapped such that player 202 can push joystick 1205 up to affect the same movement of character 720 towards the left of the page. Similarly, when player 202 is at point 914, they are looking towards the bottom of the page as drawn and can push the joystick 1205 to their right as shown to affect the same movement of character 720 towards the left of the page. When player 202 is at point 918, they are looking towards the right of the page as drawn and can push the joystick 1205 down as shown to affect the same movement of character 720 towards the left of the page.

Accordingly, as player 202 moves in a counterclockwise direction, joystick 1205 can be remapped in a clockwise direction. Joystick 1205 can be remapped at different times. For example, when player 202 is between points 920 and 814, joystick 1205 can be remapped as if player 202 were at point 810. Similarly, when player 202 is between points 814 and 912, joystick 1205 can be remapped as if player 202 were at point 910. When player 202 is between points 912 and 916, joystick 1205 can be remapped as if player 202 were at point 914, and when player 202 is between points 916 and 920, joystick 1205 can be remapped as if player 202 were at point 918.

Accordingly, when a game begins, player 202 can be at a reference point, which can be point 810. As player 202 moves more than 45 degrees in a counterclockwise direction, joystick 1205 can be remapped by 90 degrees in the clockwise direction. Joystick 1205 can be remapped as player 202 moves relative to character 710, character 720, and line 820.

In these and other embodiments of the present invention it can be undesirable for joystick 1205 or other control to be remapped as player 202 moves slightly to the left or right of point 814. Accordingly, an amount of hysteresis can be included in this remapping. This hysteresis can be spatially or temporally based. For example, as player 202 moves from point 810 to point 814, spatial hysteresis can be included where player 202 might need to move beyond point 814 a first distance to invoke a remapping. As another example, temporal hysteresis can be included such that player 202 might need to move beyond point 814 for a first duration before remapping is invoked.

In these and other embodiments of the present invention other controls can be used to control the movement of a character, such as character 720. For example, D-pad 1202, touchpad 1211, or other control on controller 230 can be used. Also, joystick 1405, touchscreen 1410, or D-pad 1402 on handheld device 1400 (shown in FIG. 14) can be used.

When D-pad 1202 is used, the left pad (a) can be used when player 202 is at point 810 to move character 720 to the left as drawn. When player 202 is at point 910, the up pad (b) can be used to move character 720 to the left as drawn. When player 202 is at point 914 the right pad (c) can be used and when player 202 is at point 918 the down pad (d) can be used to move character 720 to the left as drawn.

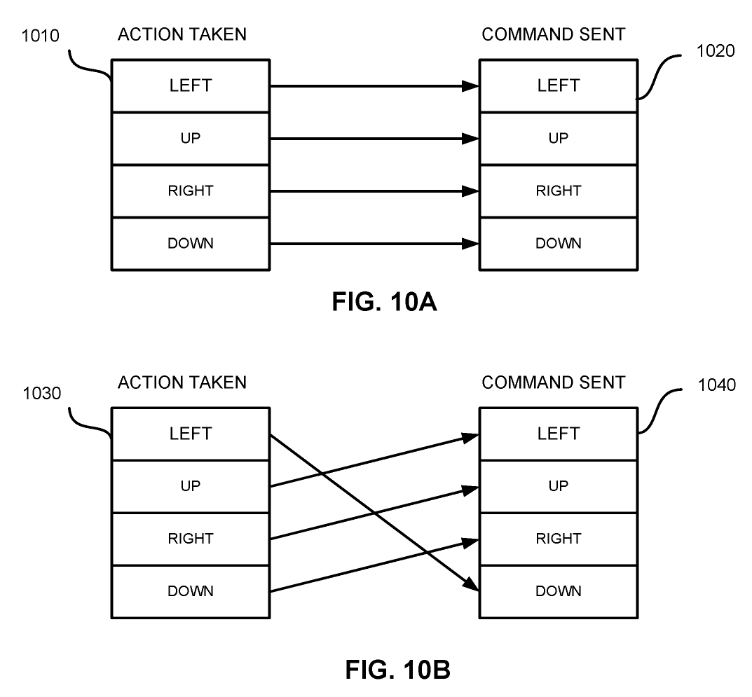

FIGS. 10A and 10B illustrate a remapping of a control to compensate for movement of a player during a game. In this example, an action is taken on a controller 230 and a resulting command is sent to console 210 or server 250. For example, an action 1010 by player 202 to push left on joystick 1205 can result in a left command 1020 sent before remapping in FIG. 10B. In FIG. 10B after remapping, an up action 1030 taken by player 202 on joystick 1205 can result in a left command 1040 sent to console 210 or server 250.

These and other embodiments of the present invention can include additional images for display. For example, a game player might map out an area using a headset or other device. The mapped area might include a glass window. A fun addition can be made to the game by determining when a character forcefully encounters the window and then adding a series of images showing the window breaking in response. The broken window can then replace the actual window in an augmented reality stream provided to the user display. The series of images can be AI generated. An example is shown in the following figure.

FIG. 11 illustrates gameplay provided by an embodiment of the present invention. In this example, player 202 can see room 700 in pass-through mode on headset 220. Console 210, television 240, and window 730 can be real-world objects that player 202 can see in pass-through mode. A combination of servers 250 (shown in FIG. 2), console 210, and headset 220 can render models for character 710 and character 720 in a manner described above. As shown in FIG. 7, character 710 can be positioned in room 700 by aligning a reference point on character 710, such as reference point 712, to a point on the floor, such as point 714. Character 720 can similarly be placed relative to the floor, or character 720 can be placed relative to the character 710. For example, reference point 722 on character 720 can be placed relative to reference point 712 of character 710, or to point 714 on the floor of room 700.

In this example, player 202 can view physical objects in room 700 along with character 710 and character 720 using headset 220. Player 202 can control character 720 with controller 230. Controller 230 can include one or more controls for controlling a direction of movement for character 720. For example, player 202 can push joystick 1205 to the left to have character move to the left.

Before the game program begins execution, headset 220 can be used by console 210 to map room 700. The position and size of structures and obstacles such as window 730 and television 240 can be read by headset 220 and stored on console 210.

During gameplay, character 710 can forcefully (in a virtual sense) encounter window 730. As a fun add-on, console 210, possibly along with servers 250, can create an image of window 730 breaking, as shown in this figure. The image of window 730 breaking can overlay or replace window 730. The images of window 730 can be generated by artificial intelligence. The images of window 730 breaking can be generated using a machine learning model that has been trained to generate images of windows breaking. The machine learning model can run on servers 250 or console 210. As another example, images of television 240 being knocked to the floor by one of character 710 or character 720 can replace the pass-through image of television 240.

Often there can be interesting or useful images displayed by a game program, where the images are not interacted with by the characters. These images can be omitted from rendering by these and other embodiments of the present invention. Instead of losing this artwork when it is not transferred to the client, these images can instead be repurposed. For example, an image of a beautiful view rendered by the game program can be repurposed as view out of window 730 or as an image on television 240. The image of interest can be provided to the client as model information. The image can then be rendered by the client as an image on an actual television in the user’s area, the client can render a virtual television and then display the image on the virtual television, the client can render as a picture on a wall in the user’s area, or the client can render the image in another location. 3D models for these images can be initially transferred along with other 3D models, such as those for character 710 and character 720. The 3D models for these images can then be rendered into interesting locations, such as window 730 or the screen of television 240.

In the above examples, draw call information and related commands and data for images to be transformed to an alternative coordinate space can be intercepted, while other draw call information and related commands and data are ignored. Similarly, audio, haptic, and other information can be selectively provided to a client device or ignored. In a fighting game, audio generated in response to actions by the combatants can be passed to a client device, where other background audio, such as a background soundtrack, might not be sent to the client device. Similarly, haptic feedback related to character’s actions can be passed to a client device, while haptic feedback not related to character’s actions might not be passed to the client device. In these examples, a client device can be a controller 230, headset 220, handheld device 1400, or other player-interfacing device.

FIG. 12 illustrates a controller that can be utilized by an embodiment of the present invention. In this example, a DualSense™ controller is illustrated as a non-limiting example of controller 230. Such a controller can include two handles 1212 and a central body 1220. Various controls can be distributed over controller 230, typically in local groups. Examples include a left button group forming a directional pad or D-pad 1202, which can comprise directional controls and one or more shoulder buttons or system buttons 1206, which can comprise function controls. Controller 230 can also include left joystick 1205 and right joystick 1204, which can also be operable as buttons by pressing down on them.

Controller 230 can include mechanisms for providing input to game console 210 (shown in FIG. 2.) For example, controller 230 can include D-pad 1202, joystick 1204, joystick 1204, buttons 1206, and triggers 1208. Combinations of D-pad 1202, one or both of joystick 1204 and joystick 1205, one or more of buttons 1206, and one or both of the triggers 1208, can be used by player 202 to provide input to game console 210. Controller 230 can also include handles 1212, which can be used to hold or grip controller 230 while an end user operates controller 230 to provide the input to game console 212. Controller 230 can also include ports 1210 that enable audio transducers included in controller 230 to record sounds in an environment surrounding controller 230 and emit audio to the environment surrounding controller 230. Although not shown, controller 230 can include other components such as one or more touch sensors for detecting physical touching of controller 230, display screens for displaying and receiving input to controller 230 (shown as the handheld device 1400 in FIG. 14), light sources (e.g., light emitting diodes) for emitting light and other signals to the environment surrounding controller 230, and the like. The foregoing mechanisms of controller 230 are not intended to be limiting and other mechanisms may be included in controller 230.

Controller 230 can also include one or more system buttons 1206, which can cause interaction with an operating system of the entertainment device or with a game or other application currently running on it; such buttons may summon a system menu or allow for recording or sharing of displayed content. Furthermore, controller 230 can comprise one or more other elements such as touchpad 1211, a light for optical tracking (not shown), a screen or display (not shown), haptic feedback elements (not shown), and the like.

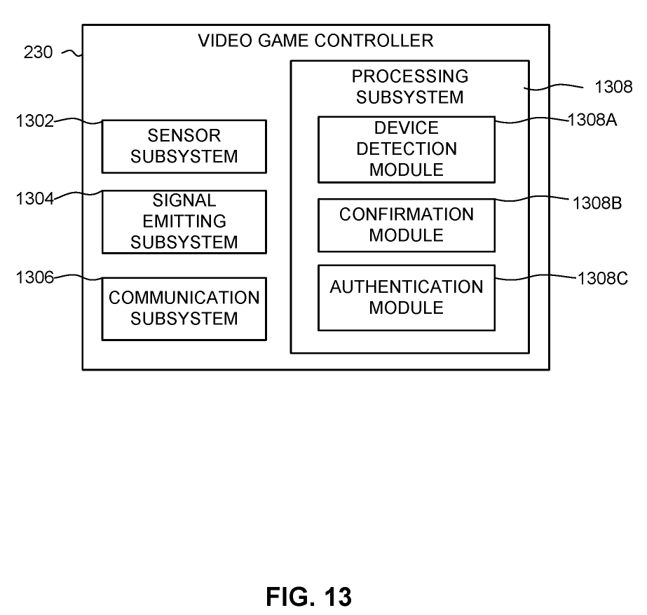

FIG. 13 is a block diagram of a controller according to an embodiment of the present invention. This block diagram can be a block diagram for a controller, such as controller 230 of FIG. 12. As shown, controller 230 can include sensor subsystem 1302, signal emitting subsystem 1304, communication subsystem 1306, and a processing subsystem 1308.

Sensor subsystem 1302 can include sensors for sensing an operation of controller 230, an external environment of controller 230 (e.g., an environment surrounding controller 230), an internal environment of controller 230 (e.g., an environment within controller 230), and the like. Examples of the sensors included in the sensor subsystem 1302 can include image sensors, infrared sensors, depth cameras, event detection sensors, light sensors, microphones, sound sensors, audio transducers, position determining sensors, ultrawide band sensors, magnetic sensors, orientation sensors, proximity sensors, accelerometers, gyroscopes, inertial measurement units (IMUs), and the like.

The signal emitting subsystem 1304 can include devices for emitting signals. A signal emitted by a device or devices of the signal emitting subsystem 1304 can include a light component (e.g., visible, and/or infrared light), an audible component (e.g., a sound), and/or a haptic feedback component (e.g., a vibration). Examples of light that can be included as a component of a signal emitted by a device or devices of the signal emitting subsystem 1304 include visible light, infrared light, laser light, steady light, strobe light, flashing light, colored light, light patterns, light beams, modulated light, and the like. Examples of audio that can be included as a component of a signal emitted by a device or devices of the signal emitting subsystem 1304 include sounds, noises, music, tones, chimes, songs, ringtones, variable volume audio, and the like. Examples of haptic feedback that can be included as a component of a signal emitted by a device or devices of the signal emitting subsystem 1304 include vibrations, surface frictions, thermal feedback, electromagnetic feedback, ultrasonic feedback, and the like. Examples of devices included in the signal emitting subsystem 1304 can include, but are not limited to, audio transducers such as speakers, light sources such as LEDs, haptic feedback devices such as a vibrator, and others.

The communication subsystem 1306 can include various hardware such as circuitry, radios, modules, transceivers, and software for enabling controller 230 to communicate using wireless and/or wired communication. For example, the various hardware and software can enable controller 230 to communicate with a network, a cloud-based storage system, another device such as another controller, electronic device, mobile phone, input device, video game console, and the like. The various hardware and software can also enable controller 230 to communicate using any wired and/or wireless communication technology, standard, protocol, and the like, and using any kind of network, public or private, wired, or wireless, and the like. Examples of such technologies, standards, and protocols include NFC, Bluetooth, IrDA; RFID; Matter; ZigBee; 3G; 4G; 5G; 6G; WLAN; Z-wave; Wi-Fi and Wi-Fi Direct; UWB; USB; ANT and ANT+; UHF; VHF; SCPS; and the like.

The processing subsystem 1308 can include one or more processors (not shown) and one or more memories (not shown). The one or more processors can read one or more programs from the one or more memories and execute them. Each processor of the one or more processors can be of any type of processor. Examples of processors include, but are not limited to, microprocessors, microcontrollers, graphical processing units, digital signal processors, application-specific integrated circuits, field programmable gate arrays, or any combination thereof. Additionally, each processor of the one or more processors can include multiple cores, arrays, coprocessors, local cache memory layers, and the like. Each memory of the one or more memories can be non-volatile and can include any type of memory or memory device that retains stored information when powered off. At least one memory of the one or more memories can include a non-transitory computer-readable storage medium from which the one or more processors can read instructions. Examples of memories, memory devices, computer-readable storage media include, but are not limited to, include electrically erasable and programmable read-only memory, flash memory, magnetic disks, memory chips, read-only memory, RAM, an ASIC, a configured processor, optical storage, and the like. The one or more processors, either individually or collectively, can execute programs stored in the one or more memories to perform the operations and/or methods, including parts thereof, described throughout.

In some implementations, processing subsystem 1308 can include, but is not limited to, device detection module 1308A, confirmation module 1308B, and authentication module 1308C. Each of device detection module 1308A, confirmation module 1308B, and authentication module 1308C can be implemented in hardware (e.g., a processor, computer circuitry, and the like), software, or a combination thereof.

The device detection module 1308A can be configured to detect whether an electronic device is within a predetermined distance from controller 230. Confirmation module 1308B can be configured to receive notifications. In some implementations, the notifications can be received from a game console such as game console 210. Authentication module 1308C can be configured to obtain a login credential for a video game player.

FIG. 14 illustrates a handheld device 1400 according to an embodiment of the present invention. In this example, a PlayStation® Portal™ is illustrated as a non-limiting example of handheld device 1400. Such a device can include two handles 1414 and a central touchscreen 1410. Various controls can be distributed over handheld device 1400, typically in local groups. Examples include a left button group forming a directional pad or D-pad 1402, which can comprise directional controls and one or more shoulder buttons or system buttons 1406, which can comprise function controls. Handheld device 1400 can also include left joystick 1405 and right joystick 1404, which can also be operable as buttons by pressing down on them.

Handheld device 1400 can include mechanisms for providing input to game console 210 or to servers 250 (shown in FIG. 2.) For example, handheld device 1400 can include D-pad 1402, joystick 1404, joystick 1405, buttons 1406, and triggers 1408. Combinations of D-pad 1402, one or both of joystick 1404 and joystick 1405, one or more of buttons 1406, and one or both of the triggers 1408, can be used by player 202 to provide input to game console 210. Handheld device 1400 can also include handles 1414, which can be used to hold or grip handheld device 1400 while an end user operates handheld device 1400 to provide the input to game console 210 or servers 250. Handheld device 1400 can also include ports (not shown) that enable audio transducers included in handheld device 1400 to record sounds in an environment surrounding handheld device 1400 and emit audio to the environment surrounding handheld device 1400. Although not shown, handheld device 1400 can include other components such as one or more touch sensors for detecting physical touching of handheld device 1400, display screens for displaying and receiving input to handheld device, light sources (e.g., light emitting diodes) for emitting light and other signals to the environment surrounding handheld device 1400, and the like. Handheld device 1400 can further include a camera (not shown) on a backside of the device. The foregoing mechanisms of handheld device 1400 are not intended to be limiting and other mechanisms may be included in handheld device 1400.

Handheld device 1400 can also include one or more system buttons 1406, which can cause interaction with an operating system of the entertainment device or with a game or other application currently running on it; such buttons may summon a system menu or allow for recording or sharing of displayed content. Furthermore, handheld device 1400 can comprise one or more other elements such as touchscreen 1410, a light for optical tracking (not shown), haptic feedback elements (not shown), and the like.

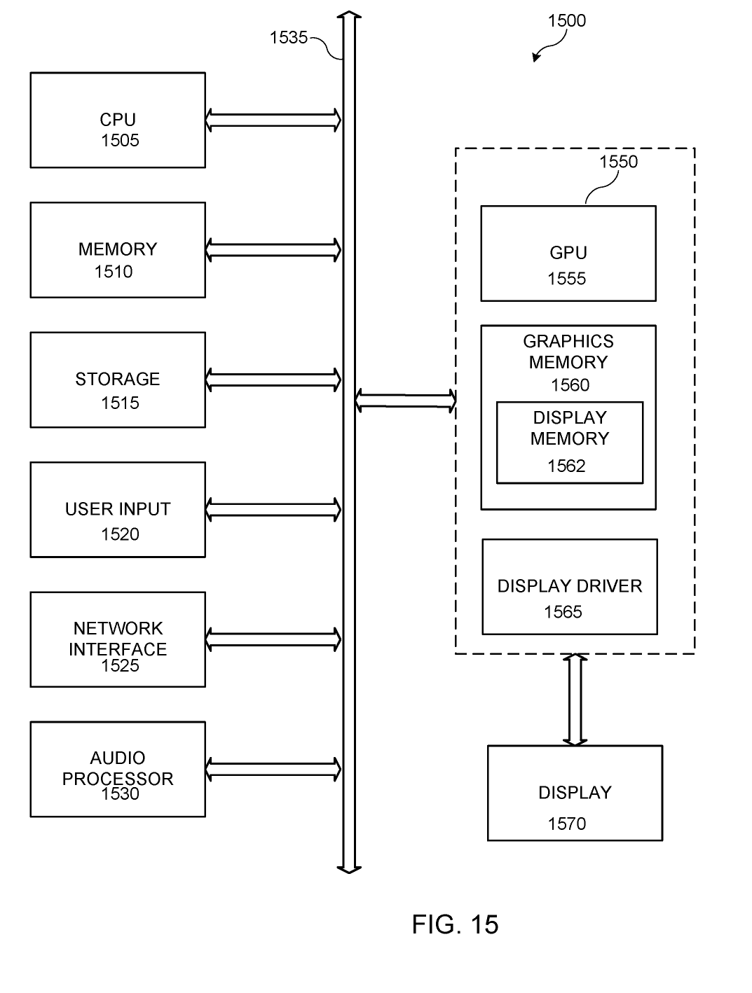

FIG. 15 illustrates a simplified block diagram of a hardware system suitable for implementing console 210 or other computer system according to an embodiment of the present invention. The computer system 1500 can be, for example, a video game system, a personal computer (e.g., laptop or desktop computer), a handheld computer (e.g., a tablet or smartphone), a server computer, or other type of computer system. Computer system 1500 can include CPU 1505 capable of running software applications and optionally an operating system. CPU 1505 can include one or more homogeneous or heterogeneous processing cores implemented in one or more integrated circuits. In some embodiments, CPU 1505 can be implemented using one or more general-purpose microprocessors and/or microprocessors whose architectures are specifically adapted for highly parallel and computationally intensive applications, such as media and interactive entertainment applications. Memory 1510 can store applications and data for use by CPU 1505 and can include any combination of volatile and/or non-volatile memory components (e.g., DRAM, SRAM, etc.). Storage subsystem 1515 can provide non-volatile storage for applications and data and may include various computer readable storage media such as fixed disk drives, removable disk drives, flash memory devices, and CD, DVD, Blu-ray, HD-DVD, or other optical storage devices. User input devices 1520 can include devices that communicate user inputs from one or more users to computer system 1500. Examples of user input devices 1520 can include keyboards, mice, joysticks, touch pads, touch screens, still or video cameras, and/or microphones. In some embodiments, some or all of user input devices 1520 can be incorporated into a handheld controller (e.g., controller 230 of FIG. 12) that communicates with other components of computer system 1500 via a wired or wireless connection. Network interface 1525 allows computer system 1500 to communicate with other computer systems via an electronic communications network. Network interface 1525 can include hardware and associated software to support wired and/or wireless communication over local area networks and/or wide area networks such as the Internet. An audio processor 1530 can be adapted to generate analog or digital audio output signals from instructions and/or data provided by CPU 1505, memory 1510, and/or storage subsystem 1515. The components of computer system 1500, including CPU 1505, memory 1510, storage subsystem 1515, user input devices 1520, network interface 1525, and audio processor 1530 can be connected via data bus 1535.

A graphics subsystem 1550 can also be connected to data bus 1535 and thereby to other components of computer system 1500. Graphics subsystem 1550 can include GPU 1555, a graphics memory 1560, and a display driver 1565. GPU 1555 can operate as a co-processor to CPU 1505 to accelerate operations associated with generating images for display. For example, GPU 1555 can support 3D rendering operations to generate pixel data for output images from instructions and data defining the geometry, lighting, shading, texturing, motion, and/or camera parameters for a scene, for instance by executing shader programs and/or other rendering programs or operations. Graphics memory 1560 can include display memory 1562 (e.g., a frame buffer) used for storing pixel data for each pixel of an output image. Graphics memory 1560 (or portions thereof) can be integrated in the same device as GPU 1555, connected as a separate device to GPU 1555, and/or implemented within memory 1510. Pixel data can be provided to display memory 1562 directly from CPU 1505. Additionally or instead, CPU 1505 can provide GPU 1555 with data and/or instructions defining the desired output images, from which GPU 1555 can generate pixel data for one or more output images and write the pixel data to display memory 1562. Display driver 1565 can periodically output pixel data for an image from display memory 1562 to display device 1570. Display device 1570 can be any device capable of displaying visual information in response to a signal from display driver 1565 that incorporates the pixel data; examples include CRT, LCD, plasma, LED, and OLED displays. Depending on implementation, display driver 1565 can provide display device 1570 with an analog or digital signal.

To implement system 200 or portions thereof, computer system 1500 can store program code implementing any or all of the modules described above. Such program code can be stored in storage subsystem 1515 and/or memory 1510 and executed using CPU 1505. A graphical user interface can be provided using a combination of display device 1570 and user input received via user input devices 1520; CPU 1505 can execute program code to display the interface and process user input.

All processes described herein are also illustrative and can be modified. Operations can be performed in a different order from that described, to the extent that logic permits; operations described above may be omitted or combined; and operations not expressly described above may be added.

While various circuits and components are described herein with reference to particular blocks, it is to be understood that these blocks are defined for convenience of description and are not intended to imply a particular physical arrangement of component parts. The blocks need not correspond to physically distinct components, and the same physical components can be used to implement aspects of multiple blocks. Components described as dedicated or fixed-function circuits can be configured to perform operations by providing a suitable arrangement of circuit components (e.g., logic gates, registers, switches, etc.); automated design tools can be used to generate appropriate arrangements of circuit components implementing operations described herein. Components described as processors or microprocessors can be configured to perform operations described herein by providing suitable program code for execution by the processor. Various blocks might or might not be reconfigurable depending on how the initial configuration is obtained. Embodiments of the present invention can be realized in a variety of apparatus including electronic devices implemented using a combination of circuitry and software.

Computer programs incorporating features of the present invention that can be implemented using program code may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may include an internal storage medium of a compatible electronic device and/or external storage media readable by the electronic device that can execute the code. In some instances, program code can be supplied to the electronic device via Internet download or other transmission paths.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein. A network may include both wired and wireless connections, including optical links. Many other examples are possible.

User interfaces for a given device can be implemented using various combinations of components. For instance, a graphical user interface may present a menu of options from which the user can select by operating an input device (e.g., mouse, joystick, buttons, etc.). A speech-based interface can be responsive to specific control words or phrases that the user may speak to change settings or invoke device functions. Some user interfaces can be implemented using switches, toggles, buttons, dials, or the like that the user can set to a desired position to control a device setting or function; feedback to the user can be provided via indicator lights, haptics, sounds, or other perceptual stimuli.

All numerical values and ranges provided herein are illustrative and may be modified. Unless otherwise indicated, drawings should be understood as schematic and not to scale. Unless otherwise stated, all measurements, values, ratings, positions, magnitudes, sizes, and other specifications that are set forth in this specification, including in the claims that follow, are approximate and are not necessarily exact. They are intended to have a reasonable range that is consistent with the functions to which they relate and with what is customary in the art to which they pertain. Terms such as “approximately” or “substantially” should be understood to reflect manufacturing tolerance or expectations in the art.

Additionally, spatially relative terms, such as “bottom” or “top” and the like can be used to describe an element and/or feature’s relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

It should also be understood that audio libraries and/or video segments may contain content that is protected by copyright. It is assumed that any use of such content would be in a manner consistent with applicable copyright restrictions.

Furthermore, embodiments can be implemented by hardware, software, firmware, middleware, microcode, hardware description languages, or any combination thereof. When implemented in software, firmware, middleware, or microcode, the program code or code segments to perform the necessary tasks can be stored in a computer-readable medium such as a storage medium. Processors can perform the necessary tasks.

It should be noted that the methods, systems, and devices discussed above are intended merely to be examples. It must be stressed that various embodiments can omit, substitute, or add various procedures or components as appropriate. For instance, it should be appreciated that, in alternative embodiments, the methods can be performed in an order different from that described, and that various steps can be added, omitted, or combined. Also, features described with respect to certain embodiments can be combined in various other embodiments. Different aspects and elements of the embodiments can be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments can be practiced without these specific details. For example, well-known circuits, processes, algorithms, structures, and techniques have been shown without unnecessary detail in order to avoid obscuring the embodiments.

Also, it is noted that the embodiments can be described as a process which is depicted as a flow diagram or block diagram. Although each can describe the operations as a sequential process, many of the operations can be performed in parallel or concurrently. In addition, the order of the operations can be rearranged. A process can have additional steps not included in the figure.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A method comprising:
with a central processing unit of a server, executing a gaming program;
with an intercept circuit of the server, detecting an Application Programming Interface (API) call; and
if the API call is for at least one game asset in a first set of game assets, then, with the intercept circuit, transmitting the API call to a client device; otherwise
ignoring the API call.

2. The method of claim 1 wherein the API call is detected after it is output by a central processing unit of the server.

3. The method of claim 1 wherein the API call is detected in an API of a graphics processing unit of the server.

4. The method of claim 3 wherein the first set of game assets comprises geometries for rendering characters for the game program.

5. The method of claim 4 further comprising not sending the API call to the graphics processing unit of the server.

6. The method of claim 4 further comprising sending the API call to the graphics processing unit of the server.

7. The method of claim 1 wherein if the API call is for the at least one game asset in the first set of game assets, then transmitting the API call to the client device over the internet.

8. A method comprising:
with a gaming system, receiving an Application Programming Interface (API) call for at least one model in a set of models;
transforming the set of models into an alternative space for display;
rendering the set of models; and
displaying the set of models in the alternative space.

9. The method of claim 8 wherein the alternative space is a pass-through view on a display of a headset.

10. The method of claim 9 wherein the alternative space is provided by a camera on the headset.

11. The method of claim 8 wherein the alternative space is displayed on a screen of a handheld device.

12. The method of claim 8 wherein the set of models comprises one or more characters.

13. The method of claim 12 wherein the game is a three-dimensional game shown from a fixed perspective of a 2D game.

14. The method of claim 9 wherein the set of models are rendered by a graphics processing unit of a game console, where the game console is in communication with the headset.

15. The method of claim 9 wherein the set of models are rendered by a graphics processing unit of the headset.

16. A method comprising:
mapping a first function to a control of a controller used by a player;
rendering a first model in an alternative space, where the alternative space is a physical area around the player;
detecting that the player has moved through an arc of a first angle relative to the first model; and
if the first angle is greater than a first threshold angle, then mapping a second function to the control on the controller, the second function different from the first function; otherwise
maintaining the mapping of the first function to the control of the controller.

17. The method of claim 16 wherein mapping the first function to the control of the controller comprises mapping the first function to at least one of a D-pad or a joystick.

18. The method of claim 17 wherein when the first function is mapped to the control of the controller, a first movement of the control moves the first model in a first direction, and when the second function is mapped to the control of the controller, the first movement of the control moves the first model in a second direction, the first direction different from the second direction.

19. The method of claim 18 wherein when the first function is mapped to the control of the controller and the player moves through an arc of more than 45 degrees, the second function is mapped to the control on the controller.

20. The method of claim 19 wherein the first model and the alternative space is viewed by the player on a display of a headset.
